(19) United States
(12) Patent Application Publication
(10) Pub. No.: US 2022/0040934 A1
(43) Pub. Date: Feb. 10, 2022

(54) INTERNAL REINFORCEMENT FOR A MOTOR VEHICLE TANK

(71) Applicant: Plastic Omnium Advanced Innovation and Research, Bruxelles (BE)

(72) Inventors: Pierre DE KEYZER, Bruxelles (BE); Laurent DUEZ, Bruxelles (BE); Bjorn CRIEL, Bruxelles (BE)

(73) Assignee: Plastic Omnium Advanced Innovation and Research, Bruxelles (BE)

(21) Appl. No.: 17/297,919

(22) PCT Filed: Nov. 28, 2019
(86) PCT No.: PCT/EP2019/082898

§ 371 Date: May 27, 2021

(30) Foreign Application Priority Data
Nov. 30, 2018 (FR) FR1872170

(51) Int. Cl. B29C 69/02; B60K 15/03; B29C 48/00; B29C 48/12; B29C 49/04; B29C 49/20

(52) U.S. Cl. CPC B29C 69/02; B60K 15/03177; B29C 48/0022; B29C 48/12; B29K 2023/065; B29C 49/20; B60K 2015/03493; B60K 2015/03032; B29C 49/04

(57) ABSTRACT

A method for manufacturing an internal reinforcement for a motor vehicle tank, the internal reinforcement being designed to connect an upper wall and a lower wall of the tank, is provided. The method includes extruding material forming a so-called extruded portion of the internal reinforcement. An internal reinforcement for a motor vehicle tank obtained by this method is also provided.

The invention relates to an internal reinforcement for a motor vehicle tank as well as to a method for manufacturing such an internal reinforcement.

An internal reinforcement that makes it possible to connect the upper wall and the lower wall of a tank is already known in the prior art, in particular from document U.S. Pat. No. 9,027,781, said internal reinforcement being produced by injection molding a plastics material. Such an internal reinforcement requires a particular shape, in particular wider ends in order to ensure the connection to the walls of the tank, and a central portion having a smaller cross-section in order to produce a breaking point for the internal reinforcement in the event of an impact, and therefore prevent rupture of the tank walls. Such a shape can be relatively complex. Furthermore, in order to modify the shape, height or even the thickness of the reinforcement, the injection mold must be modified.

Besides injection molding, a specialist in the manufacture of plastics tanks will be familiar with extrusion blow molding. An internal reinforcement produced by extrusion blow molding of a plastics material would suffer from the same drawbacks as a reinforcement produced by injection molding, namely the need to modify the blow mold if a different geometry is desired for the internal reinforcement.

The aim of the invention is in particular to provide a simpler and less expensive manufacturing method.

To this end, the invention relates to a method for manufacturing an internal reinforcement for a motor vehicle tank, the internal reinforcement being designed to connect an upper wall and a lower wall of the tank. The manufacturing method comprises a step of extruding material, referred to as extruded material, so as to form a so-called extruded portion of the internal reinforcement.

Therefore, it is proposed to use extrusion instead of injection or extrusion blow molding, even though it may seem counterintuitive to consider extrusion for such an internal reinforcement capable of having a variable cross-section in order for said reinforcement to perform its functions, in particular the function of being assembled with the walls of the tank and optionally the creation of a breaking point for the reinforcement in the event of an impact.

It is understood that the proposed method is more advantageous than the known injection and extrusion blow molding methods presented above, owing to the fact that a direction of the extruded portion can be easily varied without having to make a different mold or even make a mold in the first place. In general, this method is more advantageous than any method using a mold. It is also a more advantageous method than rolling, which is mentioned in document WO2018/115523, owing to the fact that rolling only makes it possible to produce objects that are substantially planar, unlike extrusion. Furthermore, the objects produced by rolling are generally multilayer, for example layers of wood and plastics material for a floor covering, or layers of glass and plastics material for a windshield. Extrusion allows for the manufacture of complex shapes that are monolayer or multilayer. The term “upper wall of the tank” means the wall of the tank that is intended to form the upper wall thereof when it is in the position of use provided by the manufacturer after assembly in the vehicle. Likewise, the term “lower wall of the tank” means the wall of the tank that is intended to form the lower wall thereof when it is in the position of use provided by the manufacturer after assembly in the vehicle. Finally, the term “extrusion” means extrusion without blowing, that is to say extrusion which does not require a subsequent step of blowing the extruded material in a blow mold in order to form the extruded portion of the internal reinforcement. In extrusion, the size of the extruded portion is determined by cutting.

According to other optional features of the manufacturing method, taken alone or in combination:

The manufacturing method further comprises a step of cutting the extruded portion so as to give it its size.

The step of cutting the extruded portion is performed such that the extruded portion has a cut surface, designed such that when the internal reinforcement is in place in the tank, the cut surface of the extruded portion lies in a plane that is substantially perpendicular to each of the upper and lower walls of the tank.

An original idea of the invention is to use the extruded portion in an unexpected but particularly practical orientation. Indeed, although the extruded portion might be expected to be cut in a plane which is parallel to each of the lower and upper walls of the tank once in place in the tank, a cut is made in a plane perpendicular to these walls. As a result, the width of the reinforcement can be easily varied, unlike in an injection mold or a blow mold, by generally making “slices” of the extruded portion that are wider or less wide. Such an advantage makes it possible to overcome the difficulties which could dissuade a person skilled in the art from using extrusion to produce an internal reinforcement, namely the fact that the shapes permitted by extrusion are more restrictive than those permitted by injection or extrusion blow molding, which offer more freedom with regard to the shape of the parts. Furthermore, the cut in the proposed plane can advantageously make it possible to integrate a breaking point in the internal reinforcement.

The extruded portion has an elongated shape in a so-called longitudinal direction, which corresponds to the direction that connects the upper wall and the lower wall of the tank when the internal reinforcement is in place in the tank, and the method comprises a step of cutting the extruded portion in a plane that is parallel to the longitudinal direction. This is an original way of using extrusion, as it allows the thickness of the reinforcement to be varied rather than its length.

The step of cutting the extruded portion is performed such that the extruded portion has a cut surface, designed such that when the internal reinforcement is in place in the tank, the cut surface of the extruded portion lies in a plane that is substantially parallel to each of the upper and lower walls of the tank.

The extrusion is carried out by means of an extrusion die having a variable geometry, thus making it possible, for example, to produce an extruded portion having a variable cross-section.

Therefore, when the extruded portion is cut in a plane that is substantially parallel to the upper and lower walls of the tank, it is possible to obtain a variable cross-section such that the reinforcement can perform its functions, in particular that of being assembled with the walls of the tank and optionally the creation of a breaking point for the reinforcement in the event of an impact.

When the method comprises a step of cutting the extruded portion, referred to as the first cutting step, such that the extruded portion has a cut surface, referred to as the first surface cut in a plane, referred to as the first plane, the method further comprises a second cutting step, such that the extruded portion has a second surface cut in a plane, referred to as the second plane, which is distinct from the first plane.

This makes it possible to obtain more varied internal reinforcement shapes. In particular, the first plane may be orthogonal to the second plane.

The method further comprises a step of producing at least one hole in the extruded portion.

The hole may be a hole for securing the extruded portion, for example allowing molten material to pass through in order to allow the extruded portion to be secured by strong mechanical anchoring on a wall of the tank or on an intermediate component between the extruded element and the wall of the tank, or to assemble it with another extruded portion. The securing hole may also allow a screw or a rivet to pass through. Alternatively, the hole may be a local weakening hole in the extruded portion in order to form a breaking point for the internal reinforcement in the event of an impact. In combination or as an alternative, the hole may be a hole for storing fuel and/or for passing fuel through the internal reinforcement.

The method further comprises a step of overmolding the extruded portion, in particular by means of injection, for example a step of overmolding high-density polyethylene.

The overmolding may be carried out in order to manufacture an intermediate component that makes it possible to secure the extruded portion on a wall of the tank or to assemble it with another extruded portion.

Advantageously, the overmolding is carried out on regions of the extruded portion in which holes have been made, such that the molten material fills the holes during injection so as to achieve mechanical anchoring. The overmolding temperature is lower than the melting temperature of the extruded material of the extruded portion.

The internal reinforcement comprises two extruded portions and the method comprises a step of assembling the two extruded portions together.

This makes it possible to easily vary the height of the internal reinforcement, advantageously using the same extrusion die, in particular in the case of a cut perpendicular to the walls of the tank. In the case of a cut parallel to the lower and upper walls, it should be noted that it is possible to adjust the position of the cut in order to vary the height of the internal reinforcement.

At least one of the two extruded portions comprises a plurality of means for assembly with the other extruded portion that are distributed in the longitudinal direction of the internal reinforcement so as to be able to vary the longitudinal dimension of the internal reinforcement, the longitudinal direction corresponding to the direction that connects the upper wall and lower wall of the tank when the internal reinforcement is in place in the tank. Here, again, a simple way is proposed for varying the shape of an internal reinforcement while using the same extrusion head, in this case by using an adjustable assembly of two or more extruded portions.

The method further comprises a step of assembling the extruded portion with a polymer matrix provided with reinforcing fibers, for example by means of overmolding or by means of welding. Therefore, the polymer matrix loaded with fibers provides local reinforcement to the extruded portion, such that a peripheral portion not provided with said polymer matrix can be a zone of brittleness comparable to a break zone.

The extruded portion is made of a material having:
a creep resistance characterized by an elongation of less than 1%, measured at 23° C. in air under a constant stress of 35 MPa according to the standard ISO 899-1 of 2017, and
swelling of less than 0.5% in length after 4 weeks of immersion in fuel at 50° C. and at atmospheric pressure.

The fuel used is E10 (containing 10% ethanol) and/or E22 (containing 22% ethanol) and/or M15 (containing 15% methanol). The swelling of the material is measured on test specimens manufactured according to the standard IS0527-1A of 2012 and prepared by injection.

The extruded portion is made of a material composed:
by at least 70%, by total weight of the composition, of a polymer or copolymer chosen from the group consisting of polyphthalamide (PPA), polyoxymethylene (POM), polyketone (PK), polybutylene terephthalate (PBT), polyetheretherketone (PEEK), high-density polyethylene (HDPE),
and preferably by between 15 and 30%, by total weight of the composition, of a filler chosen from the group consisting of natural or synthetic fibers, such as glass, polyethylene terephthalate or polyimide fibers.

The fibers are preferably chosen from a material compatible with said polymer, that is to say capable of adhering to the polymer. For this purpose, they can be sized, that is to say undergo surface treatment, for example with a silane or a compound derived from maleic anhydride.

The extruded portion is made of HDPE (high-density polyethylene) loaded with fibers (preferably glass fibers), the fiber content preferably being greater than or equal to 5% by total weight of the composition.

The inventors have shown that there is no significant effect at a content of less than 5%.

The extruded portion is made of HDPE loaded with fibers (preferably glass fibers), the fiber content preferably being less than or equal to 75% by total weight of the composition.

The inventors have shown that extrusion is difficult at a content of greater than 75%.

The extruded material comprises two materials which are co-extruded during the extrusion step.

It is therefore conceivable, for example, to obtain an internal reinforcement comprising a central portion made of a first material, for example a first polymer material, and ends made of a second material, for example a second polymer material, which is chemically compatible with the first material and the material of the tank walls in order to facilitate attachment of the ends to the walls. A first polymer material that is “chemically compatible” with a second polymer material is understood to mean that the polymer materials each comprise chemical species that can be welded together without requiring additional material. In other words, chemically compatible polymer materials are capable of bonding closely together by melting, and in particular of producing molecular entanglement of their respective polymer chains. The welding of the two polymer materials is understood to mean two polymer materials pressed together in the molten state such that the phenomenon of self-adhesion occurs. “Molecular entanglement of polymer chains” of a first polymer material and a second polymer material is understood to mean two polymer materials pressed together in the molten state such that self-adhesion occurs. The melting temperature of the two pressed polymer materials is measured on the basis of ISO 3146:2000. Self-adhesion of this kind is the intermolecular diffusion and entanglement of molecular chains through a polymer interface, resulting in a strong bond. Unlike adhesion, which concerns surface energy (or secondary chemical bonds between two materials that are either similar or not similar), self-adhesion concerns the entanglement of molecular chains and secondary bonds for polymer chains of similar materials. Under ideal conditions, the diffusion is complete when the interface between the two polymer materials is no longer discernible from the bulk of each of the two polymer materials. For example, in the case of two thermoplastic polymer materials, once thermoplastic polymer-thermoplastic polymer contact is achieved at the interface, intermolecular diffusion and entanglement is required to complete the process and produce a good weld. A self-adhesion phenomenon of this kind is described, for example, in the publication “Plastics and Composites Welding Handbook”, ISBN 1-56990-313-1, page 23. The molten state of the two polymer materials can be obtained in particular by friction, vibration, rotation, irradiation of the two polymer materials or by a component that heats the two polymer materials with or without contact. It is also possible to envisage that a first material, for example a polymer, is co-extruded with an internal network of filler material, for example reinforcing fibers, or with an external strip of filler material.

The co-extrusion may be carried out on a support structure, for example a hollow metal profile, which makes it possible to obtain a reinforcement comprising a hollow metal core covered by the co-extruded materials.

The invention also relates to an internal reinforcement for a motor vehicle tank, in particular an internal reinforcement made of plastics material, for example polymer material. This is obtained by a method as described above.

In a first embodiment, it is understood that such a reinforcement advantageously has no parting line from two portions of an injection mold or blow mold and no injection point or weld zone. This is particularly advantageous, because the injection point can be an unwanted element of weakness in the structure.

In a second embodiment, which relates to the joining of two extruded portions, it is understood that the extruded portion of such a reinforcement advantageously has no parting line from two portions of an injection mold or blow mold and no injection point or weld zone.

According to an optional feature of the internal reinforcement, said internal reinforcement comprises a break zone that is designed such that the internal reinforcement can deform or break in the event of an impact. The break zone is chosen from among the elements of the group of:
a local narrowing of the extruded portion,
a hole made in the extruded portion,
a zone arranged between two assembly zones of the extruded portion, each assembly zone being assembled with a polymer matrix provided with reinforcing fibers,
means for fusing the extruded portion with another extruded portion of the internal reinforcement or with a wall of the tank.

The local narrowing of the extruded portion can be obtained by an X- or Y-shaped cross-section, in particular.

Preferably, the motor vehicle tank is a fuel tank. The fuels are preferably gasolines (any gasoline on the market and in particular E10, E22 or M15).

Preferably, the motor vehicle tank is a tank made of plastics material. The plastics tank of the motor vehicle is preferably obtained by extrusion blowing a high-density polyethylene (HDPE).

### BRIEF DESCRIPTION OF THE FIGURES

The invention will be better understood on reading the description which follows, given solely by way of example and with reference to the appended drawings in which:

FIG. 1 is a schematic perspective view of an internal reinforcement for a motor vehicle tank according to one embodiment of the invention, which connects an upper wall of the tank and a lower wall of the tank which are shown partially.

FIGS. 2, 3 and 6 are schematic perspective views of internal reinforcements for a motor vehicle tank according to other embodiments of the invention.

FIG. 4a is a schematic front view of an internal reinforcement according to one embodiment of the invention.

FIG. 4b is a schematic front view of the same internal reinforcement in which the overmolded portions are not shown.

FIG. 5c is a schematic front view of an extruded portion intended to be assembled with a second extruded portion so as to form, for example, the various internal reinforcements according to one embodiment of the invention shown from the front in FIG. 5b and FIG. 5a.

FIG. 7a is a schematic front view of an extruded portion forming an internal reinforcement according to one embodiment of the invention or intended to be assembled with a second extruded portion so as to form, for example, the internal reinforcement according to one embodiment of the invention shown from the front in FIG. 7b.

FIG. 8 is a schematic view in longitudinal section of an extrusion die for manufacturing extruded portions of internal reinforcements according to another embodiment of the invention.

FIG. 9 is a partial schematic representation, viewed in longitudinal section, of an extrusion die for manufacturing extruded portions of internal reinforcements according to another embodiment of the invention.

### DETAILED DESCRIPTION

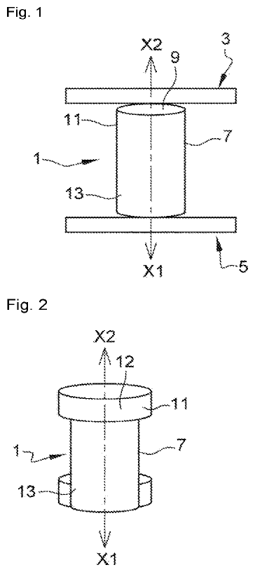

FIG. 1 shows an internal reinforcement of a motor vehicle tank according to one embodiment of the invention and denoted by the reference sign 1. The internal reinforcement 1 connects the upper and lower walls of a motor vehicle tank. Only part 3 of the upper wall and part 5 of the lower wall are shown. The internal reinforcement 1 is manufactured using a method comprising a step of extruding material, referred to as extruded material, so as to form an extruded portion 7. The internal reinforcement 1 has an elongated shape in a longitudinal direction represented by the axis X1-X2. The longitudinal direction is the direction that connects the upper wall 3 and the lower wall 5 of the tank when the internal reinforcement 1 is in place in the tank.

In all the figures showing an internal reinforcement 1, the axis X1-X2 represents the longitudinal direction, which connects the upper wall 3 and the lower wall 5 of the tank when the internal reinforcement 1 is in place in the tank.

In the embodiments of FIGS. 1 and 2, the extruded portion 7 has been cut such that the extruded portion 7 has a cut surface 9 (not visible in FIG. 2) which, when the internal reinforcement 7 is in place in the tank, is located in a plane that is substantially parallel to each of the upper 3 and lower 5 walls of the tank. The cut surface 9 is located on a longitudinal end 11 of the internal reinforcement 1. The other longitudinal end of the internal reinforcement is denoted by the reference sign 13.

In addition, in the embodiment of FIG. 2, the longitudinal ends 11 and 13 of the internal reinforcement 1 are overmolded by a material that is compatible with the material of the extruded portion 7 and the material of the walls 3 and 5 of the tank. In this embodiment, the overmolding 12 is used to secure the extruded portion to the wall of the tank 3 or 5. The overmolded material may be high-density polyethylene (HDPE).

FIG. 8 shows an extrusion die having a variable geometry. FIG. 8 also shows the extruded material 7′ that is intended to form an extruded portion of an internal reinforcement according to this embodiment of the invention. The axis X1-X2 represents the longitudinal direction, which will connect the upper wall 3 and the lower wall 5 of the tank when the internal reinforcement produced from the extruded material 7′ is in place in the tank. The die 15 of FIG. 8 has an internal diameter which varies between d1 and d2. This makes it possible to produce an extruded portion 7 having a variable cross-section. Therefore, as the extruded portion 7 is cut in a plane that is substantially parallel to the upper 3 and lower 5 walls of the tank, as in the embodiments of FIGS. 1 and 2, it is possible to obtain a variable cross-section such that the reinforcement can perform its functions, in particular that of being assembled with the walls of the tank and optionally the creation of a breaking point for the reinforcement in the event of an impact.

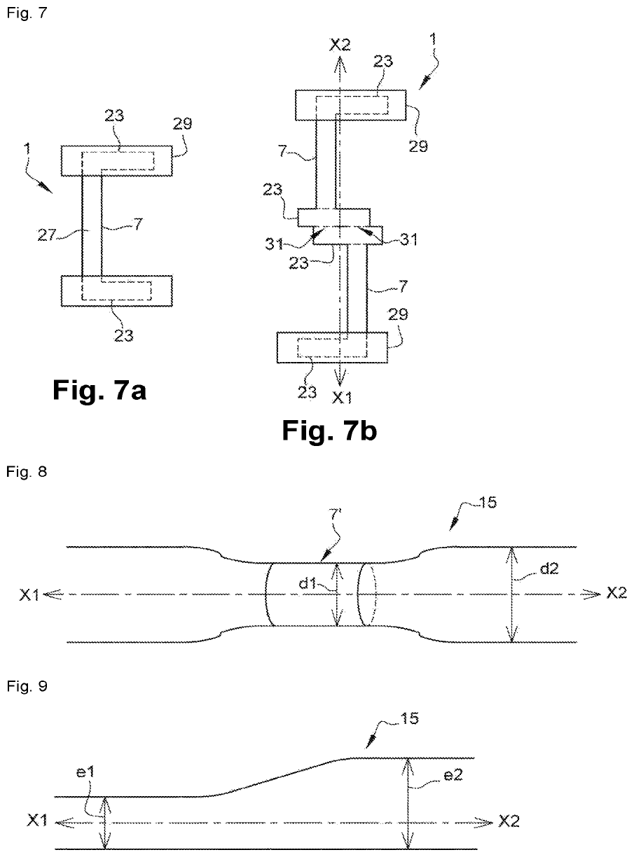

FIG. 9 shows part of an extrusion die. The axis X1-X2 represents the longitudinal direction, which will connect the upper wall 3 and the lower wall 5 of the tank when the internal reinforcement produced from the extruded material (not shown) is in place in the tank. The die portion shown in FIG. 9 is for example an arm of a die, the cross-section of which is C-shaped, like the die used to form the extruded portion shown in FIG. 7a. As shown in FIG. 9, in this embodiment, the internal diameter of the arm shown varies between e1 and e2, which makes it possible to obtain an extruded portion of which the cross-section is C-shaped and of which, for example, each of the arms has a variable thickness. It is therefore possible to obtain a reinforcement having a variable cross-section such that the reinforcement can perform its functions, in particular that of being assembled with the walls of the tank and optionally the creation of a breaking point for the reinforcement in the event of an impact.

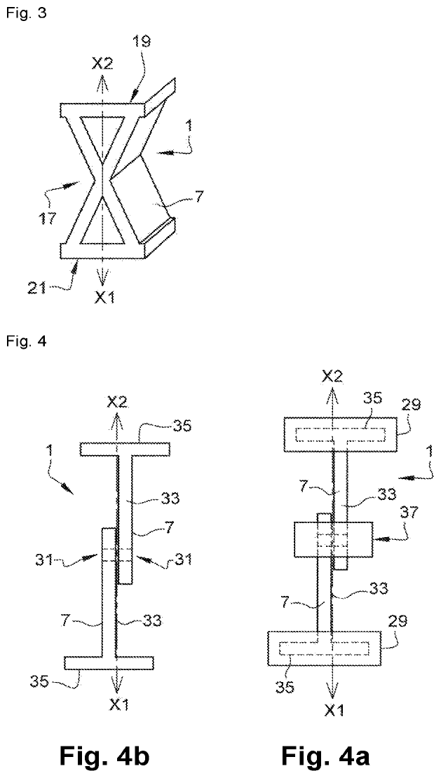

The internal reinforcements 1 of the embodiments of FIGS. 3, 4a, 4b, 5a, 5b, 6, 7a and 7b comprise an extruded portion 7 which has been cut along a plane parallel to the longitudinal direction, which is represented by the axis X1-X2. Furthermore, in these embodiments, the cut surface is designed such that when the internal reinforcement is in place in the tank, the cut surface of the extruded portion is in a plane that is substantially perpendicular to each of the upper and lower walls of the tank.

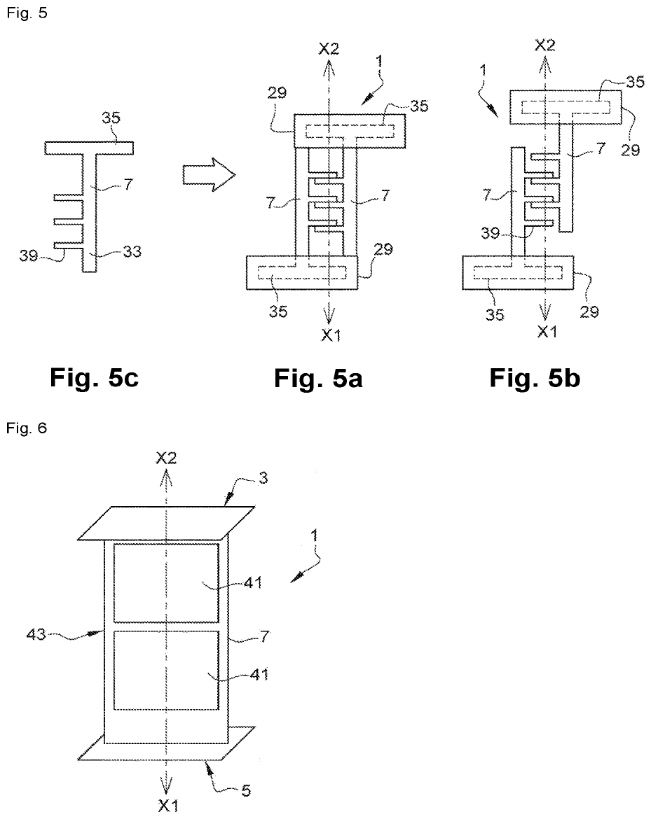

The dies used to obtain the extruded portions of these embodiments have a cross-section of a particular shape, which makes it possible to obtain an extruded portion of which the cross-section has a particular shape that complements the cross-section of the die; in other words, the shape of the cross-section of the extruded portions is dictated by the shape of the cross-section of the dies. This produces a cross-section in the shape of an X (FIG. 3), a T (FIGS. 4a and 4b), a T with side branches (FIGS. 5a and 5b), an I (FIG. 6), a C (FIG. 7b) or an H.

The use of a die having an X-shaped cross-section advantageously makes it possible to obtain an internal reinforcement 1 having a local narrowing 17 as shown in FIG. 3. The local narrowing 17 constitutes a break zone, which allows the internal reinforcement to deform or to break in the event of an impact, thus preventing rupture of the walls of the tank. In this embodiment, the X-shape is terminated at both ends by a bar 19, 21. This makes it possible to obtain a shape having wider ends 19, 21 in order to ensure the connection to the walls of the tank.

The internal reinforcement 1 of FIG. 7a has a C-shaped cross-section comprising two arms 23 separated by a central portion 27. The arms 23 form wider ends and the central portion 27 has a smaller cross-section, or local narrowing. Overmolding 29 is used to secure the ends 23 to the lower and upper walls of the tank. The overmolded material may be high-density polyethylene (HDPE).

The internal reinforcement 1 of the embodiment of FIG. 7b has two extruded portions 7 having a C-shaped cross-section. The two extruded portions 7 are assembled together by means of two holes 31 each made in an arm 23 of each extruded portion 7. The holes 31 allow the extruded portions 7 to be secured to one another, for example allowing molten material (not shown) to pass through in order to achieve securing by strong mechanical anchoring. The securing hole 31 may also allow a screw or a rivet (not shown) to pass through. This makes it possible to easily vary the height of the internal reinforcement, advantageously using the same extrusion die. Furthermore, the means (31) for assembling the two extruded portions (7) together may constitute a break zone for the internal reinforcement 1.

Similarly, two extruded portions 7 having a T-shaped cross-section are shown assembled together in FIGS. 4a and 4b. The T-shape comprises a rod 33 that is parallel to the longitudinal direction X1-X2 and a rectangular head 35 that is perpendicular to the longitudinal direction X1-X2 and parallel to each of the upper and lower walls of the tank. A hole 31 is made in each of the rods 33 in order to allow them to be assembled together. An overmolding 37 is produced at the level of the holes so as to achieve mechanical anchoring by filling the hole 31 with the molten material 37. The height of the internal reinforcement will easily be varied depending on the height at which the hole is made.

FIG. 5c shows an extruded portion 7 having a T-shaped cross-section with side branches 39. In order to assemble the two portions 7, as shown in FIGS. 5a and 5b, at least one side branch 39 of one of the extruded portions 7 is brought into abutment with at least one side branch 39 of the other extruded portion 7. Each side branch 39 thus constitutes a means for assembly with the other extruded portion and each extruded portion 7 comprises a plurality of means for assembly with the other extruded portion 7 that are distributed in the longitudinal direction of the internal reinforcement 1. As a result, the longitudinal dimension of the internal reinforcement 1 can be varied.

FIG. 6 shows an extruded portion 7 having an I-shaped cross-section. Two sheets 41 of polymer matrix provided with reinforcing fibers are assembled on the extruded portion 7 in two distinct assembly zones. The zone 43 provided between the two assembly zones of the extruded portion 7 constitutes a break zone for the internal reinforcement 1.

It should be understood that a person skilled in the art will be able to envisage a multitude of other embodiments of a reinforcement having an extruded portion as proposed.

1. A method for manufacturing an internal reinforcement for a motor vehicle tank, the internal reinforcement being designed to connect an upper wall and a lower wall of the tank, the method comprising:
a step of extruding material, referred to as extruded material, so as to form a so-called extruded portion of the internal reinforcement.

2. The manufacturing method according to claim 1, further comprising a step of cutting the extruded portion so as to give it its size.

3. The manufacturing method according to claim 2, wherein the step of cutting the extruded portion is performed such that the extruded portion has a cut surface, designed such that when the internal reinforcement is in place in the tank, the cut surface of the extruded portion lies in a plane that is substantially perpendicular to each of the upper and lower walls of the tank.

4. The manufacturing method according to claim 2, wherein the step of cutting the extruded portion is performed such that the extruded portion has a cut surface, designed such that when the internal reinforcement is in place in the tank, the cut surface of the extruded portion lies in a plane that is substantially perpendicular to each of the upper and lower walls of the tank, and the extrusion is carried out by means of an extrusion die having a variable geometry, thus making it possible, for example, to produce an extruded portion having a variable cross-section.

5. The manufacturing method according to claim 1, further comprising a step of producing at least one hole in the extruded portion.

6. The manufacturing method according to claim 1, further comprising a step of overmolding the extruded portion, in particular by means of injection, for example a step of overmolding high-density polyethylene.

7. The manufacturing method according to claim 1, wherein the internal reinforcement comprises two extruded portions and the method comprises a step of assembling the two extruded portions together.

8. The manufacturing method according to claim 7, wherein at least one of the two extruded portions comprises a plurality of means for assembly with the other extruded portion that are distributed in the longitudinal direction of the internal reinforcement so as to be able to vary the longitudinal dimension of the internal reinforcement, the longitudinal direction corresponding to the direction that connects the upper wall and lower wall of the tank when the internal reinforcement is in place in the tank.

9. The manufacturing method according to claim 1, wherein the extruded material comprises two materials which are co-extruded during the extrusion step.

10. An internal reinforcement for a motor vehicle tank obtained by means of a method according to claim 1.

11. The internal reinforcement according to claim 10, comprising a break zone of the internal reinforcement that is designed such that the internal reinforcement can deform or break in the event of an impact, the break zone being chosen from among the elements of the group of:
a local narrowing of the extruded portion,
a hole made in the extruded portion,
a zone arranged between two assembly zones of the extruded portion, each assembly zone being assembled with a polymer matrix provided with reinforcing fibers,
means for fusing the extruded portion with another extruded portion of the internal reinforcement or with a wall of the tank.
